(19) United States
(12) Patent Application Publication
(10) Pub. No.: US 2025/0214032 A1
(43) Pub. Date: Jul. 3, 2025

(54) HEAT EXCHANGER WITH INTEGRATED HORIZONTAL FILTRATION

(71) Applicant: Ingersoll-Rand Industrial U.S., Inc., Davidson, NC (US)

(72) Inventors: Henry Y Mark, West Chester, PA (US); Nicholas Prochorenko, West Chester, PA (US); Scott A Johnson, Honey Brook, PA (US)

(21) Appl. No.: 19/088,381

(22) Filed: Mar. 24, 2025

Related U.S. Application Data
(63) Continuation-in-part of application No. 18/310,292, filed on May 1, 2023.
Application No. 18/310,292 is a continuation of application No. 17/025,446, filed on Sep. 18, 2020, now Pat. No. 11,660,568.

(51) Int. Cl. B01D 53/26; F26B 11/02; F26B 23/00

(52) U.S. Cl. CPC B01D 53/266; B01D 53/265; F26B 23/004; B01D 2257/80; F26B 11/028

(57) ABSTRACT

An air drying unit for compressed air systems includes a precooler/reheater, a main cooler, and a moisture separator. Incoming air is cooled to cause moisture within the compressed air to condense, and the condensate separated to dry the compressed air. The air drying unit includes an integrated intake filtration and outtake filtration sections with horizontally oriented filter elements that filter particulates and oil from incoming and outgoing compressed air.

### BACKGROUND

Compressed air is used in various applications including residential, commercial, and industrial applications including but not limited to driving pneumatic tools, painting, bottle forming, and cleaning, to name a few. For example, factories have a centralized compressed air system installed that feeds a network of compressed air piping that supplies numerous tools or stations with compressed air. Thus, one or more centralized air compressors may be used to supply an entire factory space with compressed air.

However, it is known that air compressors that draw air from the surrounding atmosphere also introduce moisture into the compressed air from the water vapor naturally contained in atmospheric air. Moisture within compressed air used in factories can cause numerous problems. For example, in the case of power tools that use compressed air as a power source, moisture within the supplied compressed air can cause corrosion of the internal components of the tool. In addition, where compressed air is blown onto surfaces, any moisture within the compressed air will also be blown onto the surface along with the blown air. This moisture can be particularly problematic where it is a requirement that the surface remains dry, such as in food packaging operations, and can also be a problem for delicate surfaces that water particles can damage. Moisture can result in mold & fungus growth and lead to other undesirable effects.

Due to the problems associated with moisture within compressed air systems, various types of air drying systems that utilize heat exchangers may be used in industrial factories or in other applications to remove moisture contained within compressed air. While such systems are useful and adequately address the potential problems associated with moisture in compressed air, such systems can be large in size and are not always effective in matching the required compressed air demand.

### BRIEF DESCRIPTION OF THE DRAWINGS

The Detailed Description is described with reference to the accompanying figures.

The accompanying figures, where like reference numerals, refer to identical or functionally similar elements throughout the separate views and which, together with the detailed description below, are incorporated in and form part of the specification, serve to further illustrate various embodiments and to explain various principles and advantages all in accordance with the systems and methods disclosed herein.

Skilled artisans will appreciate that elements in the figures are illustrated for simplicity and clarity and have not necessarily been drawn to scale. For example, the dimensions of some of the elements in the figures may be exaggerated relative to other elements to help improve understanding of embodiments of the systems and methods disclosed herein.

FIG. 1 is a perspective view of a 3-in-1 air drying unit, according to embodiments of the present disclosure;

FIG. 2 is another perspective view of the air drying unit of FIG. 1 from the reverse side;

FIG. 3 is a schematic view of the air drying unit of FIG. 1 showing compressed airflow through passages within the air drying unit;

FIG. 4 is a perspective view of multiple air drying units, such as the air drying of of FIG. 1, connected together;

FIG. 5A is an exploded view of a clamp;

FIG. 5B is a cross-section view of a portion of the clamp of FIG. 5A;

FIG. 6 is a perspective exploded view of a 5-in-1 air drying unit with integrated intake and outtake filtration sections, according to embodiments of the present disclosure.

FIG. 7A is a cross-section view of an intake filtration section of an air drying unit, such as the air drying unit of FIG. 6, according to embodiments of the present disclosure.

FIG. 7B is a cross-section view of an outtake filtration section of an air drying unit, such as the air drying unit of FIG. 6, according to embodiments of the present disclosure.

FIG. 8 is a perspective exploded view of a 5-in-1 air drying unit with integrated intake and outtake filtration sections, according to embodiments of the present disclosure.

FIG. 9 is a perspective exploded view of a 5-in-1 air drying unit with integrated intake and outtake filtration sections, according to embodiments of the present disclosure.

FIG. 10 is a perspective exploded view of a 5-in-1 air drying unit with integrated intake and outtake filtration sections, such as the air drying unit of FIG. 9, depicting a filter diffuser for an intake filter element, according to embodiments of the present disclosure.

FIG. 11A is a perspective exploded view of a shroud and slot filter diffuser for an intake filter element, according to embodiments of the present disclosure.

FIG. 11B is a perspective exploded view of a helical filter diffuser for an intake filter element, according to embodiments of the present disclosure.

FIG. 12 is a cross-section view of an intake filtration section, such as the intake filtration section of FIG. 9, that includes a helical filter diffuser, such as the helical filter diffuser of FIG. 11B, according to embodiments of the present disclosure.

FIG. 13 is a perspective view of a filter element with various filter connections used for an intake filter element or an outtake filter element for an air dryer unit, according to embodiments of the present disclosure.

FIG. 14 is a perspective exploded view of a 5-in-1 air drying unit with integrated intake and outtake filtration sections, according to embodiments of the present disclosure.

FIG. 15 is a perspective exploded view of a 5-in-1 air drying unit with integrated intake and outtake filtration sections, according to embodiments of the present disclosure.

FIG. 16 is a perspective exploded view of a 5-in-1 air drying unit with integrated intake and outtake filtration sections, according to embodiments of the present disclosure.

FIG. 17 is a perspective exploded view of a 5-in-1 air drying unit with integrated intake and outtake filtration sections, according to embodiments of the present disclosure.

FIG. 18 is a perspective exploded view of a 5-in-1 air drying unit with integrated intake and outtake filtration sections, according to embodiments of the present disclosure.

FIG. 19 is a perspective exploded view of two 5-in-1 air drying units with integrated intake and outtake filtration sections coupled together for increased drying capacity, according to embodiments of the present disclosure.

### DETAILED DESCRIPTION

Aspects of the disclosure are described more fully hereinafter with reference to the accompanying drawings, which form a part hereof, and which show, by way of illustration, example features. The features can, however, be embodied in many different forms and should not be construed as limited to the combinations set forth herein; rather, these combinations are provided so that this disclosure will be thorough and complete and will fully convey the scope.

All documents mentioned herein are hereby incorporated by reference in their entirety. References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Thus, the term “or” should generally be understood to mean “and/or” and so forth.

Recitation of ranges of values herein are not intended to be limiting, referring instead individually to any and all values falling within the range, unless otherwise indicated herein, and each separate value within such a range is incorporated into the specification as if it were individually recited herein. The words “about,” “approximately,” or the like, when accompanying a numerical value, are to be construed as indicating a deviation as would be appreciated by one of ordinary skill in the art to operate satisfactorily for an intended purpose. Ranges of values and/or numeric values are provided herein as examples only and do not constitute a limitation on the scope of the described embodiments. The use of any and all examples, or exemplary language (“e.g.,” “such as,” or the like) provided herein, is intended merely to better illuminate the embodiments and does not pose a limitation on the scope of the embodiments. No language in the specification should be construed as indicating any unclaimed element as essential to the practice of the embodiments.

In the following description, it is understood that terms such as “first,” “second,” “top,” “bottom,” “up,” “down,” and the like, are words of convenience and are not to be construed as limiting terms.

Brazed plate and fin-type heat exchangers include plates and internal channels that provide an extended surface for optimal heat transfer between two fluid streams. These heat exchangers can be fabricated of aluminum, stainless steel, or other conductive materials that allow optimal packaging. The heat exchangers transfer heat between two fluid streams (one could be a moisture-laden gas, and heat transfer would occur with a gas and a cooling medium (e.g., a refrigerant gas or a liquid heat transfer medium)). Heat exchangers can also be a multi-layer heat exchanger containing passages for a gas that is to be cooled that transfers energy from a cooled phase change material, which in turn is cooled by a refrigerant gas or other type of cooling medium, as an example. In the case of a compressed air dryer designed with a plate-type combined heat exchanger (3-in-1) featuring a precooler/reheater section, chiller section, and integrated moisture separator, contaminants introduced upstream of the air dryer can create failure criteria for the heat exchanger. The arrangement is such that the precooler/reheater section is adjacent to the cooling (chiller) section, and the cooled fluid exiting the precooler/reheater would be required to turn 90 degrees prior to entering the chiller section. These sections can be welded or bolted together.

Such contaminants can include pipe scale, particulates brought in through the compression process, and bulk oil introduced by the compressor. Fouling of the passages of the heat exchanger can occur with iron debris, leading to corrosion points that will cause the heat exchanger to fail. It is critical to protect the heat exchanger from this contamination for the heat exchanger in order to have a proper service life.

In a typical air dryer installation, an intake filter is installed in the piping upstream of the air dryer itself to help protect the heat exchanger. Although installing the filter helps protect the heat exchanger, the piping between the intake filter and the dryer can still experience pipe rust and scale, which can foul the heat exchanger. Thus, it would be desirable to have a solution that solves this reliability problem while delivering a complete air treatment package in a single package and to minimize downtime, installation cost, and installed footprint.

Also, for a typical condensate draining process, each time a condensate drain is activated, compressed air is discharged, leading to wasted energy and increased operating costs for the system as it typically requires four to five horsepower or 2.94 to 3.67 kW of power to generate 1 SCFM of pressurized air. By eliminating the drain for the intake filter and outlet filter and removing the need for discharging and the subsequent loss of compressed air, the overall efficiency of the system can be improved. Thus, the arrangement presented by the embodiments described herein of an intake filtration section design allows for condensed moisture to be carried downward into a precooler/reheater section, thus eliminating the need for a separate dedicated condensate draining device such as a float drain (which is prone to clogging), an electric solenoid drain, or an electronic no air loss drain while reducing installation complexity. In a traditional embodiment where a separate inlet filter assembly comprised of a head and a removal filter bowl is employed, a separate drain is required to expel the condensate collected in the vertical bowl. This embodiment helps to reduce the cost and additional componentry required. Moreover, the intake filtration section reduces overall pressure drop to provide improved efficiency of the system compared to a traditional cast filter, which would otherwise force air with additional energy through a tortuous path before exiting the housing. The horizontal element design eliminates the number of directional flow changes when the fluid is conveyed through a traditional vertical filter assembly.

Embodiments disclosed herein relate to a combined heat exchanger formed of aluminum or stainless steel (or any other type of materials with desirable heat transfer properties) that incorporates a horizontal intake filtration section, precooler/reheat section, chiller section, integrated moisture separator, and horizontal outtake filtration section used for removing moisture from a compressed gas stream. This 5-in-1 type heat exchanger allows filtration, which typically accompanies an air dryer, to be integral to the heat exchanger in a compact design compared to a more traditional 3-in-1 exchanger with separate filtration.

Each heat exchanger section can be customized to optimize the efficiency for the desired operating conditions. The plates that form the heat exchanger are typically joined together using a brazing process or any suitable process that provides a seal that can withstand the desired operating pressures.

The moisture separator section of the combined heat exchanger assembly is arranged to allow liquid droplets of condensed water vapor in the chiller section of the assembly to drop out due to a change in velocity. The bottom of the moisture separator section contains a condensate drain port.

The heat exchanger includes a horizontal inlet and outlet connection that are parallel to each other, and this design allows for a simplified piping connection that eliminates elbows, which can result in added pressure drop and construction costs. The horizontal connection enables the heat exchanger to be used as a standalone system or coupled to another heat exchanger to form a larger flow capacity in a compact arrangement. In embodiments, multiple heat exchangers are joined together utilizing a grooved pipe joining connection to simplify the assembly process and do not require welding. Unlike other types of heat exchanger construction arrangements, the inlet and outlet header arrangements permit connection configurations such as a) both inlet and outlet from the back or front in the same plane and b) opposing inlet and outlet connections in the same plane.

The heat exchanger also incorporates structural mounting points to secure the device to a structural frame. In embodiments, the system includes internal temperature measurement points to allow a remote control device (e.g., controller, processor, computing system, or the like) to monitor and control the cooling system to achieve optimal energy savings.

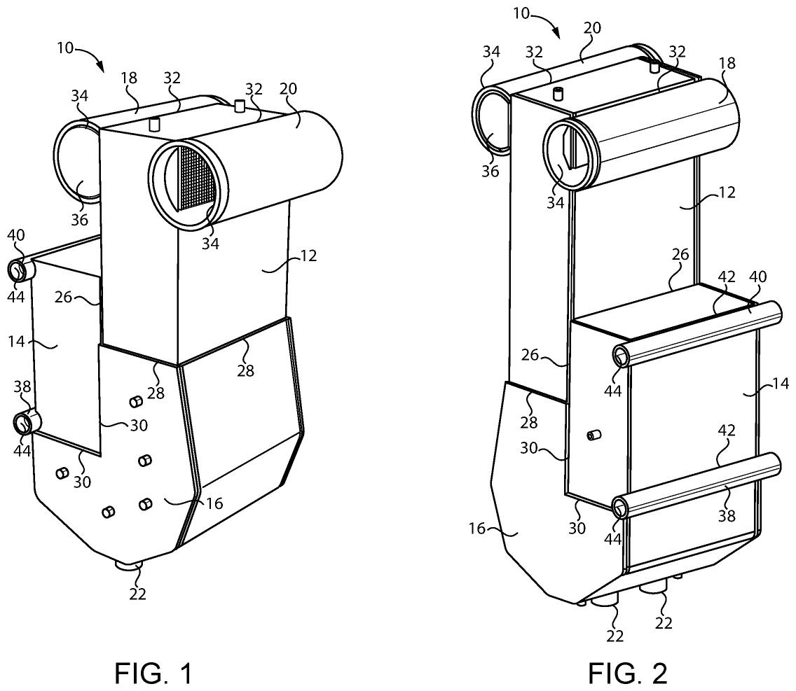

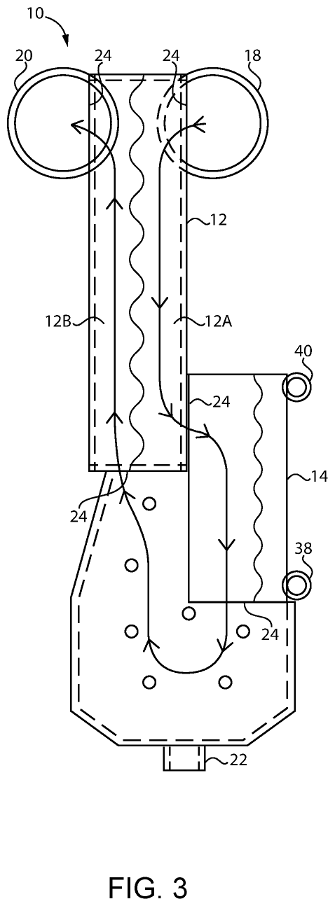

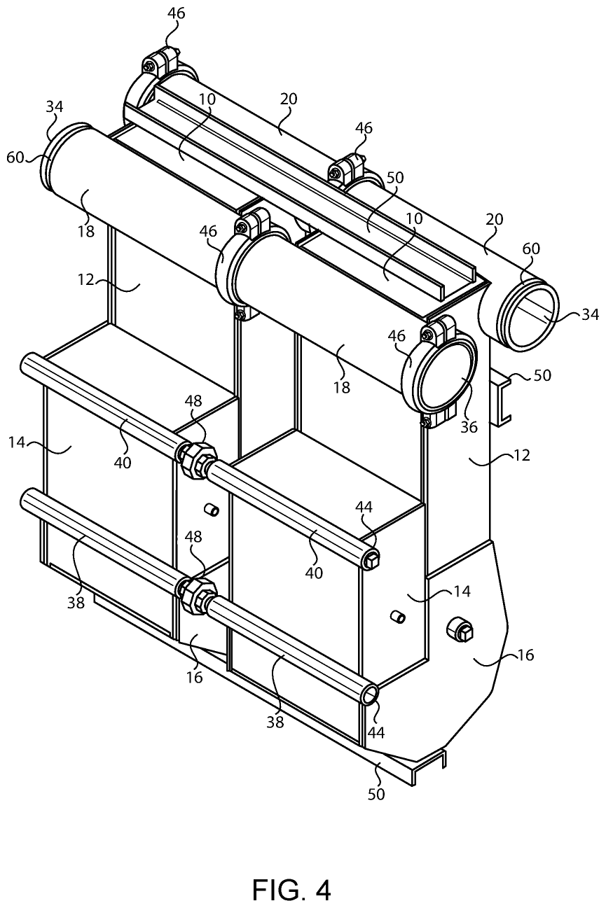

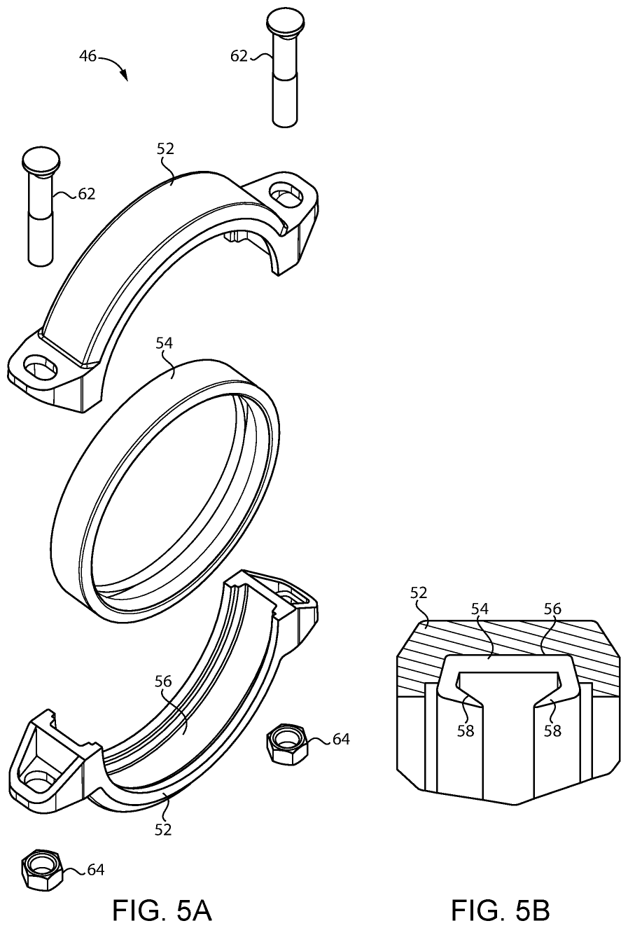

Referring now to FIGS. 1 through 4, an air drying unit 10 is provided with three main components, in other words, a 3-in-1 heat exchanger. The air drying unit 10 has a precooler/reheater 12, a main cooler 14, and a moisture separator 16. During operation, compressed air from the air inlet 18 enters the precooler side 12A of the precooler/reheater 12. The air then exits the precooler/reheater 12 and enters the main cooler 14. After cooling the compressed air, the air enters the moisture separator 16. In embodiments, the moisture separator 16 is within the main cooler 14 or is a separate component located after the main cooler 14. The air then reenters the precooler/reheater 12 on the reheater side 12B and exits the air drying unit 10 through the air outlet 20.

Herein, “main cooler,” “chiller section,” and “chiller” are used interchangeably and refer to the same or equivalent components, structures, or functions unless otherwise specified. Moreover, herein, “inlet” and “intake” are used interchangeably, and “outlet” and “outtake” are used interchangeably.

The precooler/reheater 12 is a heat exchanger that exchanges heat between the incoming and outgoing airflow so that the incoming compressed airflow is warmer than the outgoing compressed airflow. As described herein, the air is cooled within the drying unit 10 to withdraw moisture from the compressed air. Thus, the precooler/reheater 12 increases efficiency by cooling the incoming air with the outgoing air before additional cooling occurs. In general, outgoing air should not be too cool since this would cool the downstream compressed air piping system and cause condensation of water vapor on the exterior of the piping since the ambient dew-point would be higher than the surface temperature of the compressed air piping. Thus, the precooler/reheater 12 prevents the outgoing compressed air from becoming too cool by heating the outgoing compressed air using the warm incoming compressed air. Moreover, by having the incoming warm compressed air warm the outgoing cool air, conversely, the outgoing cool air cools the incoming warm air. Thus, thermal heat is desirably transferred between stages of the airflow before and after the moisture separator 16, thereby reducing heat losses from the system and providing an overall reduction of energy required to cool the compressed air in the main cooler 14. Consequently, the thermal transfer between the precooler and the reheater for the compressed air allows for a size reduction of the main cooler 14 compared to a system without a precooler/reheater 12.

The main cooler 14 comprises another heat exchanger that predominantly cools the compressed air, as accomplished by the various embodiments disclosed herein. In general, cooling the incoming compressed air by the main cooler 14 is done to cause the moisture (i.e., a gaseous vapor, such as water vapor) within the compressed air to condense into a fluid state (e.g., liquid water), which is then removed from the system (via drain 22) leaving the outgoing compressed air “dryer” than the incoming compressed air. In one embodiment, the main cooler 14 uses a liquid coolant, such as a glycol and water mixture, to cool the compressed air. In this embodiment, the main cooler 14 is a liquid-air heat exchanger. In another embodiment, the main cooler 14 uses a refrigerant to cool the compressed air. In this embodiment, the refrigerant side of the main cooler 14 serves as an evaporator where the refrigerant evaporates and absorbs heat from the compressed air side of the main cooler 14. In further embodiments, the main cooler 14 may utilize a liquid coolant and a refrigerant. In embodiments, the main cooler 14 cools the incoming compressed air to below 5° C. In further embodiments, the main cooler 14 cools the incoming compressed air as low as 0° C.

After the main cooler 14 cools the incoming compressed air, the moisture separator 16 withdraws moisture from the compressed air. In this arrangement, the compressed air, which has moisture removed, is now considered the “dried” outgoing compressed air. In embodiments, the compressed air is then diverted, e.g., via a U-turn, and flows upward from the moisture separator 16. In embodiments, the moisture separator 16 is located below the main cooler 14, allowing gravity to remove the condensed fluid through a drain 22. In embodiments where multiple drying units 10 are used together, further embodiments have the respective drains 22 of the air drying units 10 connected together to provide a single drain system. In another embodiment, a separate drain is provided for each 5 in 1 heat exchanger to allow for independent condensate management. In the single drain system configuration, an equalizing line can be installed thru a fitting such as 200 or 162 on the outlet air section to prevent air lock with a single air circuit.

The outgoing compressed air then enters the reheater side 12B of the precooler/reheater 12 and exits the drying unit 10 through the air outlet 20. It is understood that airflow through the air drying unit 10 need not be separately forced or circulated throughout but instead flow through the drying unit 10 on an on-demand basis as compressed air is used and replaced by the compressed air supply. That is, any compressed air that flows to the compressed air demand from the compressed air supply must first pass through the drying unit 10 (or another drying unit 10 in the system) due to the location of the drying unit 10 between the supply and demand.

Generally, the drying unit 10 is designed to be compact and integral as a single unit. Thus, unit 10 may be smaller than other conventional air dryers with equivalent capacity. In other words, the precooler/reheater 12, main cooler 14, and moisture separator 16 are interconnected to form unit 10 without being connected with pipes and pipe couplers or fasteners such that air flows between the precooler/reheater 12, main cooler 14, and moisture separator 16 through internal passages 24 within the drying unit 10. In order to contain the air within the unit 10, the unit 10 is sealed sufficiently to contain compressed air. Thus, in some embodiments, while unit 10 is formed as a monolithic unit incorporating the precooler/reheater 12, main cooler 14, and moisture separator 16, the respective sections are welded (e.g., brazed) to each other so that the components are permanently connected and sealed together (e.g., the internal passages 24 are sealed by the welds). For example, the precooler/reheater 12 is welded 26 to the main cooler 14 and is welded 28 to the moisture separator 16. In some instances, the main cooler 14 is also welded 30 to the moisture separator 16.

In some embodiments, in order to make the drying unit 10 vertically compact, the precooler/reheater 12 partially overlaps vertically with the main cooler 14 such that the bottom end of the precooler/reheater 12 is laterally adjacent to the top end of the main cooler 14. Moreover, in some embodiments, the precooler/reheater 12 and the main cooler 14 are offset from each other and partially overlap in a side-by-side arrangement so that the incoming compressed air changes direction at the end of the precooler/reheater 12 to flow laterally from the precooler/reheater 12 to enter the main cooler 14. As a result, the height of the drying unit 10 is reduced.

In order to make the drying unit 10 modular and more easily used with multiple drying units 10 as described further below, the air inlet 18 and air outlet 20 may be pipes 18, 20 extending across the width of the unit 10. In this arrangement, the axes of the pipes 18, 20 (which extend parallel to each other) extend in one direction across the unit 10, but the compressed air must flow laterally with respect to the pipe axes in order to enter and exit the drying unit 10. This arrangement may be accomplished by forming (e.g., cutting) a side opening through each pipe 18, 20 to fit the pipe 18, 20 against the drying unit 10 and welding 32 the pipe 18, 20 to the drying unit 10. Thus, the compressed air flows laterally from or to the respective pipe 18, 20 to enter and exit the drying unit 10. The openings 34 at the opposite ends of the pipes 18, 20 may be used to connect the drying unit 10 to the compressed air supply and compressed air demand. In some embodiments, the inlet pipe 18 and the outlet pipe 20 have equal lengths and are longitudinally aligned with each other so that the end openings 34 of the two pipes 18, 20 extend out from the drying unit 10 the same length. In some embodiments, one end 34 of each pipe 18, 20 is closed with a plug or cap 36 when an additional drying unit 10 is not connected to the unit 10. In embodiments, the inlet and outlet pipes 18, 20 are connected to the compressed air system of the facility on the same side of the drying unit 10 or on opposite sides as desired. In some embodiments, pressure measurement taps are provided in the air inlet and outlet pipes 18, 20 for measuring a pressure drop across the drying unit 10.

A similar arrangement may also be used for the coolant pipes 38, 40. The inlet 38 and outlet 40 coolant pipes allow the coolant to flow into and out of the main cooler 14. In embodiments, the coolant pipes 38, 40 are cut and shaped to the side of the main cooler 14 and are welded 42 to the main cooler 14. Like the air inlet and outlet pipes 18, 20, the coolant flows laterally from the respective pipe 38, 40 to enter and exit the main cooler 14. In some embodiments, the coolant pipes 38, 40 are the same length and aligned with each other so that the end openings 44 of the two pipes 38, 40 extend out from the drying unit 10 with the same length. It is understood that various arrangements may be used for the coolant pipes 38, 40 depending on the particular application and whether a liquid coolant or a refrigerant is used. The cooling header connections shown on coolant pipes 38, 40 are shown with tubular header connections (i.e., end openings 44) and can be formed using a rectangular or non-round section with connections and can have connections along the middle of the cooling header instead of at the ends.

One advantage of the drying unit 10 is that multiple drying units 10 chained together in parallel, relative to compressed air supply and demand, increases drying and airflow capacity. It is understood that because the air drying units 10 have a common design, manufacturing the units 10 is more efficient. Also, performing maintenance on the units 10 in operation may be easier due to their commonality. Because adding each additional unit 10 increases compressed air drying capacity in an additive fashion, compressed air demand can also be matched more closely, and capacity may be added to a factory later if needed merely by adding additional drying units 10.

By connecting the air inlet pipes and air outlet pipes of multiple drying units 10, the drying units 10 are arranged in parallel between the compressed air supply and the compressed air demand. In other words, when multiple air drying units 10 are connected and operating simultaneously, the compressed airflow from the supply is split into separate portions that flow through separate drying units 10. Thus, in arrangements where two drying units 10 are connected in parallel, the compressed airflow is divided in half due to the pressure differences so that half the compressed air flows from the air inlets 18 through each drying unit 10. The divided compressed airflow portions are then recombined at the air outlets 20 after flowing through the multiple drying units 12 and supplied to the compressed air demand. Therefore, by connecting the air inlet pipes 18 together and the air outlet pipes 20 of multiple units 10 together, the connected pipes 18, 20 act as a common inlet header and a common outlet header. The air inlet and outlet pipes 18, 20 can be connected to a coupling or fitting, such as a tee, elbow, or straight pipe section, which serves as a central pipe carrying compressed air to the assembly. In some embodiments, the tee, elbow, or straight pipe is used to connect to the compressed air system of the facility. In embodiments, which will be further described and illustrated below in reference to the 5-in-1 type heat exchanger, an intake filter and/or outlet filter with the same grooved or flanged connection is connected to the drying unit 10 assembly to filter the compressed air entering and exiting the assembly.

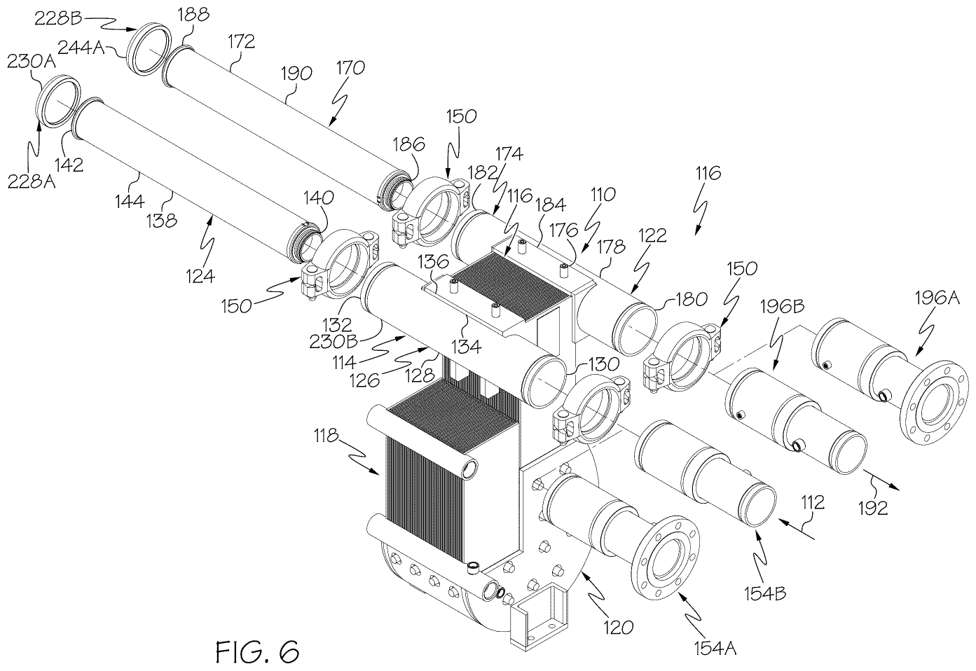

In embodiments, the air inlet pipes 18 and the air outlet pipes 20 are each connected with a clamp 46 that wraps around the ends 34 of two adjacent pipes 18, 20. Thus, the units 10 are not connected with intervening pipes but are located directly adjacent to each other with a single clamp 46 connecting two adjacent pipe ends 34 together. In some embodiments, such as shown in FIGS. 5A and 5B, the clamps 46 have rigid (e.g., metal) half-round clamp members 52 with a circular groove 56. In embodiments, a flexible round seal (e.g., plastic) 54 is located in the central groove 56 of the clamp members 52. The seal 54 has ends 58 that are pressed into corresponding grooves 60 in the air inlet and outlet pipes 18, 20. Fasteners (e.g., bolts 62 and corresponding nuts 64) are used to tighten the two clamp members 52 together and squeeze the seal 54 against the ends 34 of the pipes 18, 20.

In embodiments, a similar connection is made with the coolant inlet pipes 38 and the coolant outlet pipes 40. In this embodiment, the coolant pipes 38, 40 are directly connected to corresponding adjacent coolant pipes 38, 40 with a pipe coupler (e.g., a swivel connector) without intervening pipes. Just as described above, this arrangement results in the coolant pipes 38, 40 acting as common headers where the coolant is split evenly between the main coolers 14 of the units 10 so that equal portions flow from the coolant inlet pipes 38 into the main coolers 14, and the coolant is recombined in the coolant outlet pipes 40 after flowing through the main coolers 14. This arrangement is advantageous when a liquid coolant is used in contrast to a refrigerant, which, in some instances, is fed directly to each main cooler separately.

In accordance with the present disclosure, the air drying units 10 are easily added (coupled) together to satisfy increased compressed air demand while providing a compact package and common design. In some embodiments, in addition to connecting the drying units 10 together with the pipes 18, 20, 38, 40 and connecting fasteners 46, 48, multiple drying units 10 are further secured together using structural supports 50.

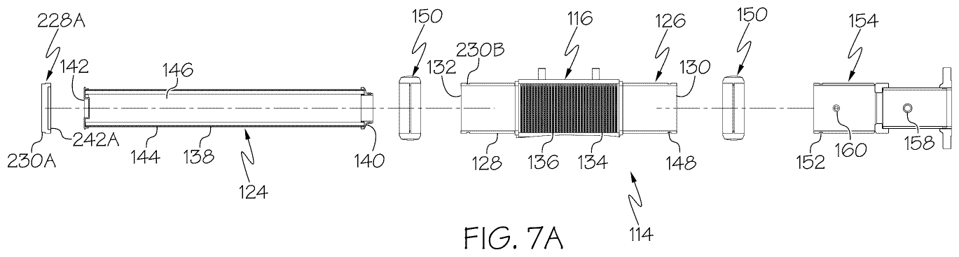

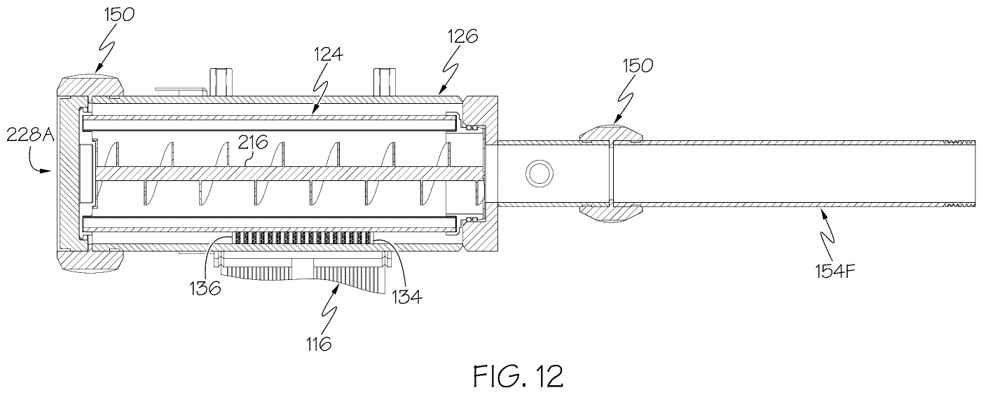

Referring now to FIGS. 6 through 19, an air drying unit 110 is provided with five main components, in other words, a 5-in-1 heat exchanger. During operation, compressed air supplied by an air compressor is conveyed to the air dryer unit 110 using a steel piping system with a rough internal surface. The pressured inlet air (i.e., incoming compressed air 112) is generally saturated with moisture as part of the compression process, and this moisture will cause the internal steel piping surface to corrode over time. Scale formation and other contaminants can damage heat exchangers, which are fabricated using aluminum plates and channels. Fouling of the passages can occur with iron debris. This fouling can lead to corrosion points that can cause the heat exchanger to fail. The embodiments disclosed herein provide an air drying unit 110 with integrated filtration that reduces scale and contaminants from the incoming compressed air prior to the air entering the air drying unit 110 and upon the air exiting the air drying unit 110, thus also reducing scale and contaminants from reaching compressed air equipment located downstream from the air drying unit 110.

The air drying unit 110 includes an intake filtration section 114, a precooler/reheater section 116 (e.g., precooler/reheater 12), a chiller section 118 (e.g., main cooler 14), a moisture separator section 120 (e.g., moisture separator 16), and an outtake filtration section 122. In some embodiments, the air drying unit 110 is the air drying unit 10 (i.e., 3-in-1 heat exchanger) discussed in the description of FIGS. 1 through 4, that further includes an intake filtration section 114 and an outtake filtration section 122 to form a 5-in-1 heat exchanger.

In general, hot, moist air (i.e., incoming compressed air 112) enters the intake filtration section 114 of the air drying unit 110 where an intake filter element 124 removes particulates, bulk moisture, and bulk oil, thus protecting the air drying unit 110 from fouling and failure as previously described.

The intake filtration section 114 includes an intake filter housing 126 that houses an intake filter element 124, which removes contaminants from the incoming compressed air 112. In embodiments, the intake filter housing 126 is integrated with the air drying unit 110. The intake filter housing 126 eliminates the need for a separate filter housing and drain. Moreover, by housing an intake filter element 124 horizontally respective to a precooler air intake 136 of the precooler/preheater section 116, the intake filtration section 114 reduces undesired pressure drops to the compressed air system.

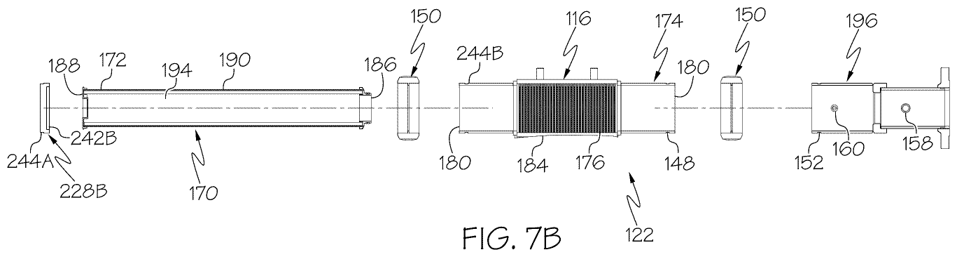

In general, the intake filter housing 126 also functions as an intake header for the air drying unit 110 (and may be referred to as an intake header herein). In embodiments, such as the embodiment shown in FIG. 7A, the intake filter housing 126 includes a sidewall 128 that defines a first opening 130, a second opening 132, and a third opening 134. As shown, the first opening 130 faces opposite to the second opening 132, and the third opening 134 is located on the sidewall 128 between the first opening 130 and the second opening 132. The third opening 134 is coupled to a precooler air intake 136 of the precooler/reheater section 116. As arranged, the intake filter housing 126 receives compressed air from the first opening 130 to the third opening 134.

As the incoming compressed air 112 enters the inlet header (i.e., the intake filter housing 126) of the air drying unit 110, debris and condensate are captured by a intake filter media 138 of the intake filter clement 124, whereby the condensate in the inlet airstream drains into the precooler/reheater section 116 and the chiller section 118.

As described, the intake filter element 124 is housed by the intake filter housing 126. In embodiments, the intake filter clement 124 has a first opening 140, an end cap 142, and a sidewall 144. In embodiments, the first opening 140 faces opposite to the end cap 142. In embodiments, the sidewall 144 of the intake filter element 124 is formed of an intake filter media 138 configured to filter the incoming compressed air 112 that passes through the intake filter media 138. For example, the incoming compressed air 112 entering the first opening 130 of the intake filter housing 126 enters the first opening 140 of the intake filter clement 124, passes outward through the sidewall 144 formed of the intake filter media 138, and exits the intake filter housing 126 through the third opening 134 of the intake filter housing 126. In other words, the incoming compressed air 112 enters axially into the cavity 146 defined by the intake filter element 124 and passes radially from the cavity 146 through the intake filter media 138 to capture residual debris.

In embodiments, for example, the embodiment shown in FIG. 7A, the intake filter housing 126 includes a circumferential groove 148 located proximate to the first opening 130. In this embodiment, the circumferential groove 148 receives a grooved fitting 150 (e.g. clamp 46 using ends 58) that couples the intake filter housing 126 to a respective circumferential groove 152 on an onsite pipe connection 154 that supplies the incoming compressed air 112. Various embodiments of onsite pipe connection 154 that supply the incoming compressed air 112 are depicted as pipe connections 154A-H.

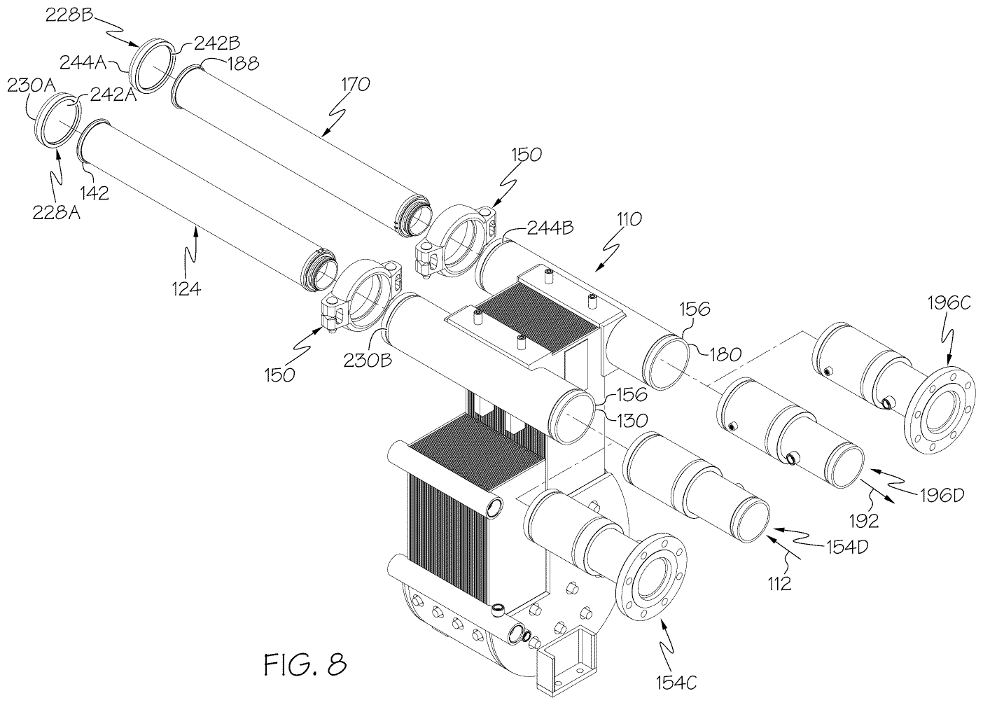

In embodiments, for example, the embodiment shown in FIG. 8, the intake filter housing 126 includes a beveled edge 156 located proximate to the first opening 130 that receives a weld fitting which couples the intake filter housing 126 to the respective onsite pipe connection 154 (i.e., pipe connection 154C or 154D). The beveled edge of 156 is similar to 230B and would use grooved coupling 150 to join the piping sections as shown. If the grooved coupling 150 is not used, the connections can be welded to beveled edge 156. These can also be joined using flanges welded to each section and bolted together.

In embodiments, for example, the embodiment shown in FIG. 7A, the onsite pipe connection 154 receives a portion of the intake filter element 124. In this embodiment, the onsite pipe connection 154 includes a first pressure measurement tap 158 and a second pressure measurement tap 160, such that the first pressure measurement tap 158 receives an internal air pressure of the intake filter element 124 and the second pressure measurement tap 160 receives an external air pressure of the intake filter element 124. In this arrangement, comparison between the internal air pressure and the external air pressure of the intake filter element 124 determines a condition state of the intake filter element 124. For example, a relatively low pressure differential indicates that the intake filter element 124 is functioning nominally, whereas a relatively high pressure differential indicates that the intake filter element 124 is clogged and requires maintenance.

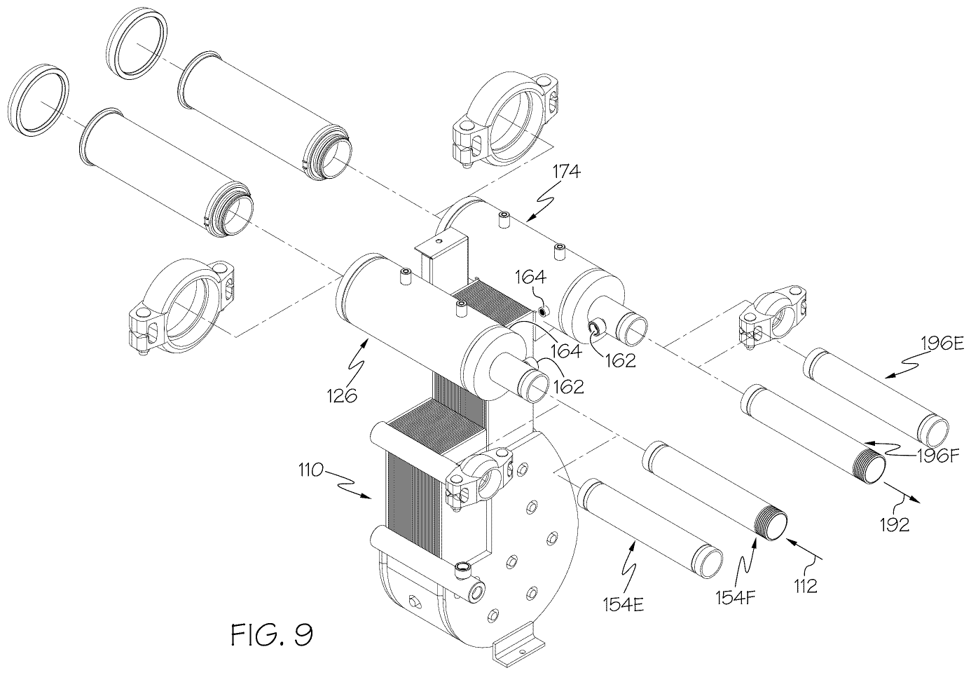

In another embodiment, shown in FIG. 9, the intake filter housing 126 includes a first pressure measurement tap 162 and a second pressure measurement tap 164. In this embodiment, the first measurement tap 162 receives an internal air pressure of the intake filter element 124 and the second pressure measurement tap 164 receives an external air pressure of the intake filter element 124, wherein the pressure differential between the two determines a condition state of the intake filter element 124. For example, a relatively low pressure differential indicates that the intake filter element 124 is functioning nominally, whereas a relatively high pressure differential indicates that the intake filter element 124 is clogged and requires maintenance.

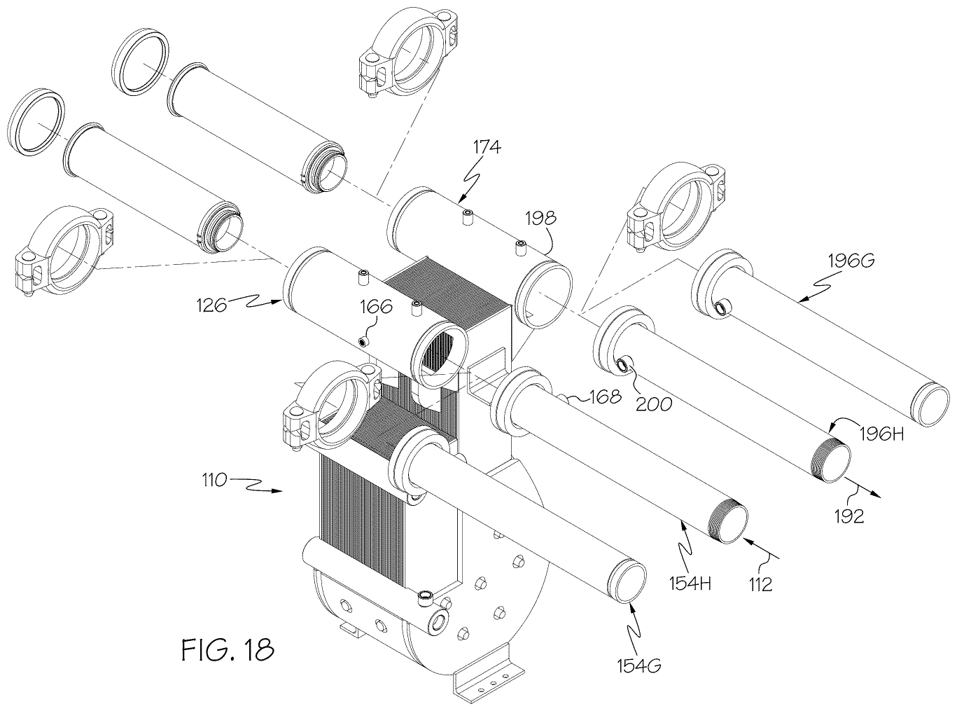

In yet another embodiment, shown in FIG. 18, the intake filter housing 126 includes a first pressure measurement tap 166 while an onsite pipe connection 154 includes a second pressure measurement tap 168. In this embodiment, the first measurement tap 166 receives an external air pressure of the intake filter element 124 and the second pressure measurement tap 168 receives an internal air pressure of the intake filter element 124, wherein the pressure differential between the two determines a condition state of the intake filter element 124. For example, a relatively low pressure differential indicates that the intake filter element 124 is functioning nominally, whereas a relatively high pressure differential indicates that the intake filter element 124 is clogged and requires maintenance. In other embodiments, measurement tap 166 is used for measurements of temperature, pressure, humidity, or any other type of quality measurement.

From the intake filtration section 114, hot and moist compressed air enters the precooler air intake 136 of the precooler/reheater section 116 where it is precooled (typically reducing the temperature of the compressed air from approximately 100° F. down to approximately 60° F.) in the precooler portion (e.g., precooler side 12A) by the outgoing chilled air of the reheater portion (e.g., reheater side 12B). Thus, precooler/reheater section 116 is a heat exchanger for transferring heat between the incoming and outgoing compressed air such that the outgoing compressed air precools the incoming compressed air and the incoming compressed air reheats the outgoing compressed air.

The overall heat transfer performance of the precooler/reheater section 116 depends on the number of plates. In general, the construction of the precooler/reheater section 116 is arranged to be offset from the chiller section 118 in order to reduce the overall height of the air dryer unit 110.

From the precooler portion, the precooled compressed air then enters the chiller section 118 where the temperature of the precooled compressed air is further chilled (typically reducing the temperature of the precooled compressed air from approximately 60° F. down to approximately 38° F.) through a heat transfer process with a cooling medium. In embodiments, the cooling medium can be, but is not limited to, a chilled glycol solution (i.e., an air-to-glycol mixture heat exchange configuration, such as used in cycling refrigerated dryers). The cooling medium is circulated through the chiller section 118, or is in contact with a direct expansion refrigeration system (i.e., air-to-refrigerant heat exchange configuration, such as used in non-cycling refrigerated dryers). As the chiller section 118 chills the compressed air, gaseous vapor (e.g., water vapor) suspended in the compressed air is thus condensed into a liquid state. Thus, the main cooler (i.e., the chiller section 118) is a heat exchanger coupled to the precooler/reheater section 116 to receive the precooled compressed air, and is configured to receive a coolant for exchanging heat between the precooled compressed air and the coolant such that the coolant chills the precooled compressed air to cause moisture in the precooled compressed air to condense.

In embodiments, the flow through the precooler/reheater section 116 and the chiller section 118 are arranged in a counter-flow configuration to optimize heat transfer performance. In embodiments, the chiller section 118 includes a stacked plate counter-flow heat exchanger section that cools and condenses the gaseous vapor from the compressed air stream. In embodiments, the plates can be sandwiched between perforated or corrugated sheet material, creating an extended surface area for enhanced heat transfer.

As the chilled compressed air exits the chiller section 118 and enters the moisture separator 120, the condensed liquid (e.g., liquid water) separates by gravity and accumulates at the bottom of the moisture separator 120. The moisture separator 120 directs the chilled compressed air in a 180-degree turn in airflow. This directional change allows for improved moisture separation such that the condensed droplets of liquid are centrifugally flung to the periphery (such as the bottom and adjacent surfaces thereto) of the moisture separator 120. The size of the moisture separator 120 is selected based on the desired flow rate of the compressed gas stream and further sized so as to create a low-velocity zone that permits the droplets of liquid condensate to fall out from the chilled compressed air flow and to prevent re-entrainment of moisture from being carried to the inlet of the precooler/reheater section. The moisture separator 120 further includes drainage ports to allow the liquid condensate to drain from the air drying unit 110. For example, at the bottom of the moisture separator 120, one or more condensate drain holes (e.g., drain 22) are provided for discharging the condensate liquid that accumulates in a sump area during the chilling process. In general, the thickness of the walls of the moisture separator 120 are selected to meet desired operating pressures.

The chilled compressed air then exits the moisture separator 120 and enters the reheater portion (e.g., reheater side 12B) of the precooler/reheater section 116 where the chilled compressed air is reheated by the hot incoming air entering the precooler portion.

Afterward, the reheated and dry compressed air enters the outtake filtration section 122 of the air dryer unit 110, where an outtake filter element 170 removes particulates and ensures that the reheated and dry compressed air delivered downstream is further filtered from contaminants that may have passed through the intake filter element 124. The reheated and dry compressed air exiting the precooler/reheater section 116 enters an outer face of the outtake filter element 170, whereby any excess debris is captured as the compressed air passes through an outtake filter media 172 and exits through the center (i.e., axially) of the outtake filter element 170. Any debris carried by the compressed air exiting through the precooler/reheater section 116 is carried and then forced into a 90-degree turn into the outtake filter element 170 before exiting the air drying unit 110. This flow path prevents debris/particles from being carried into the outlet stream, and the bottom of the outlet air header (i.e., outtake filter housing 174) serves as a collection point for debris.

In embodiments, the outtake filtration section 122 includes an outtake filter element 170 that removes contaminants from the compressed air. As the compressed air enters the outlet air header, debris is captured by the outlet filter media 172. In embodiments, the compressed air passes radially through the outlet filter element 170 to capture residual debris and exits the filter element through its center (i.e., axially).

The outtake filtration section 122 includes an outtake filter housing 174 that houses an outtake filter element 170 that removes contaminants from compressed air exiting the reheater portion of the precooler/reheater section 116. In embodiments, the outtake filter housing 174 is integrated with the air drying unit 110, thus eliminating the need for a separate filter housing. Moreover, by housing the outtake filter element 170 horizontally with respect to a reheater air outtake 176 of the precooler/reheater section 116, the outtake filtration section 122 reduces undesired pressure drops to the compressed air system.

In general, the outtake filter housing 174 also functions as an outtake header for the air drying unit 110 (and may be referred to as an outtake header herein). In embodiments, such as the embodiment shown in FIG. 7B, the outtake filter housing 174 includes a sidewall 178 that defines a first opening 180, a second opening 182, and a third opening 184. As shown, the first opening 180 faces opposite to the second opening 182, and the third opening 184 is located on the sidewall 178 between the first opening 180 and the second opening 182. The third opening 184 is coupled to a reheater air outtake 176 of the precooler/reheater section 116. As arranged, the outtake filter housing 174 receives compressed air from the third opening 184 to the first opening 180.

As the exiting compressed air enters the outtake header (i.e., the outtake filter housing 174) of the air drying unit 110, debris is captured by the outtake filter media 172 of the outtake filter element 170. As shown, the outtake filter element 170 is housed by the outtake filter housing 174. In embodiments, the outtake filter element 170 has a first opening 186, an endcap 188, and a sidewall 190. The first opening 186 faces opposite to the endcap 188. In embodiments, the sidewall 190 of the outtake filter element 170 is formed of an outtake filter media 172 configured to filter the exiting compressed air that passes through the outtake filter media 172. For example, the compressed air exiting the reheater portion enters the third opening 184 of the outtake filter housing 174, passes inward through the sidewall 190 formed of the outtake filter media 172, exits the outtake filter element 170 through the first opening 186, and then exits the outtake filter housing 174 through the first opening 180 of the outtake filter housing 174, thus defining the outgoing compressed air 192 of the system. Thus, the compressed air enters radially inward into a cavity 194 defined by the outtake filter element 170 through the intake filter media 138 to capture residual debris and passes axially from the cavity 194 through the first opening 186.

In embodiments, for example the embodiment shown in FIG. 7B, the outtake filter housing 174 includes a circumferential groove 148 located proximate to the first opening 180. In this embodiment, the circumferential groove 148 receives a grooved fitting 150 (e.g. clamp 46 using ends 58) that couples the outtake filter housing 174 to a respective circumferential groove 152 on an onsite pipe connection 196 (i.e., pipe connection 196A or 196B) that receives the outgoing compressed air 192. Various embodiments of onsite pipe connection 196 that receive the outgoing compressed air 192 are depicted as pipe connections 196A-H.

In embodiments, for example, the embodiment shown in FIG. 8, the outtake filter housing 174 includes a beveled edge 156 located proximate to the first opening 180 that receives a weld fitting that couples the outtake filter housing 174 to the respective onsite pipe connection 196 (i.e., pipe connection 196C or 196D).

In embodiments, for example, the embodiment shown in FIG. 7B, the onsite pipe connection 196 receives a portion of the outtake filter element 170. In this embodiment, the onsite pipe connection 196 includes a first pressure measurement tap 158 and a second pressure measurement tap 160, such that the first pressure measurement tap 158 receives an internal air pressure of the outtake filter element 170 and the second pressure measurement tap 160 receives an external air pressure of the outtake filter element 170. In this arrangement, a comparison between the internal air pressure and the external air pressure of the outtake filter element 170 determines a condition state of the outtake filter element 170. For example, a relatively low pressure differential indicates that the outtake filter element 170 is functioning nominally, whereas a relatively high pressure differential indicates that the intake filter element 170 is clogged and requires maintenance.

In another embodiment, for example the embodiment shown in FIG. 9, the outtake filter housing 174 includes a first pressure measurement tap 162 and a second pressure measurement tap 164. In this embodiment, the first measurement tap 162 receives an internal air pressure of the outtake filter element 170 and the second pressure measurement tap 164 receives an external air pressure of the outtake filter element 170, and the pressure differential between the two determines a condition state of the outtake filter element 170. For example, a relatively low pressure differential indicates that the outtake filter element 170 is functioning nominally, whereas a relatively high pressure differential indicates that the intake filter element 170 is clogged and requires maintenance.

In yet another embodiment, for example the embodiment shown in FIG. 18, the outtake filter housing 174 includes a first pressure measurement tap 198 while an onsite pipe connection 196 includes a second pressure measurement tap 200. In this embodiment, the first measurement tap 198 receives an external air pressure of the outtake filter element 170 and the second pressure measurement tap 200 receives an internal air pressure of the outtake filter element 170, and the pressure differential between the two determines a condition state of the outtake filter element 170. For example, a relatively low pressure differential indicates that the outtake filter element 170 is functioning nominally, whereas a relatively high pressure differential indicates that the intake filter element 170 is clogged and requires maintenance. In other embodiments, measurement tap 198 is used for measurements of temperature, pressure, humidity, or any other type of quality measurement.

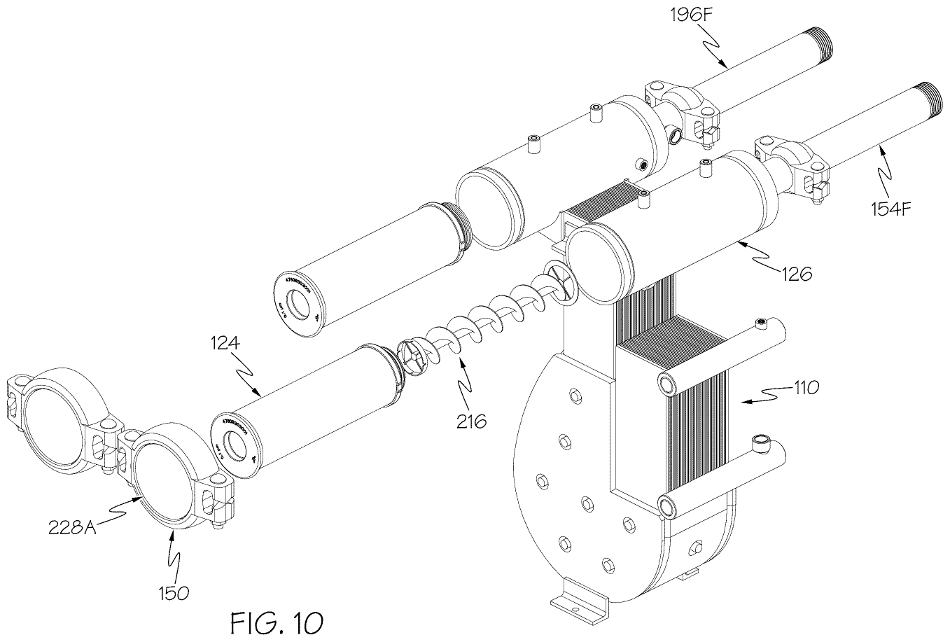

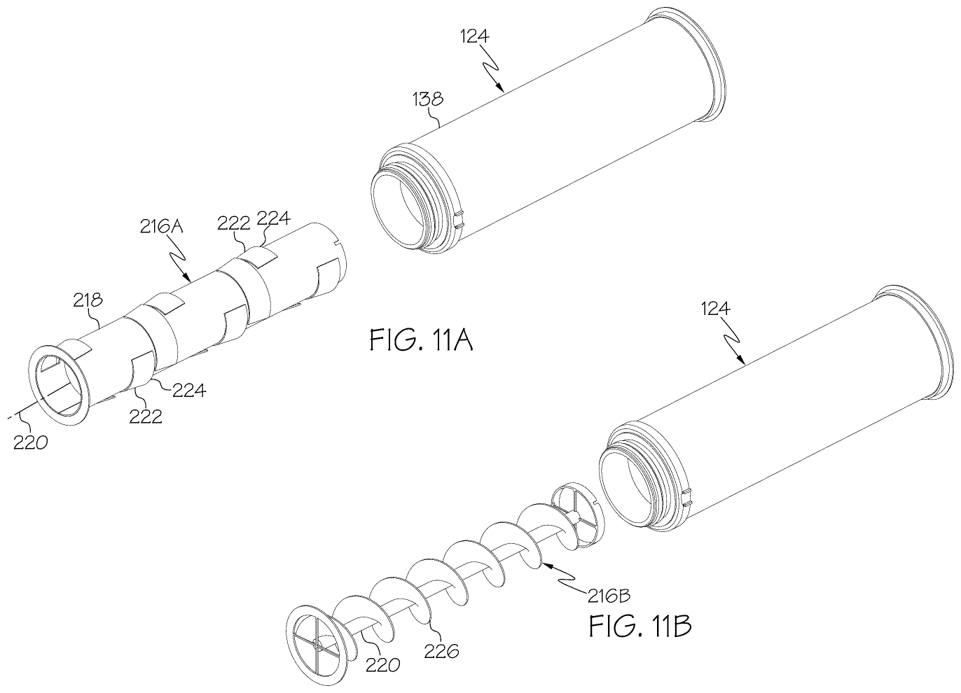

In embodiments, for example to the embodiments shown in FIGS. 10, 11A-B, and 12, the intake filter element 124 houses a filter diverter or a diffuser 216 that maintains an even (or at least substantially even) air distribution onto the intake filter media 138 to limit the compressed air from seeking potentially weaker filtration portions of the intake filter media 138 having a path of lesser resistance. In some embodiments, the filter diffuser 216 is a shroud and slot diffuser 216A that includes a tubular barrier 218 that extends along an axis 220 of the filter diffuser 216. In such embodiments, the tubular barrier 218 includes multiple shrouds 222 that radially extend from the tubular barrier 218. The multiple shrouds 222 respectively define multiple slots 224 that diffuse the compressed air. In other embodiments, the filter diffuser 216 is a helical diffuser 216B that includes a helical barrier 226 that extends along an axis 220 of the filter diffuser 216.

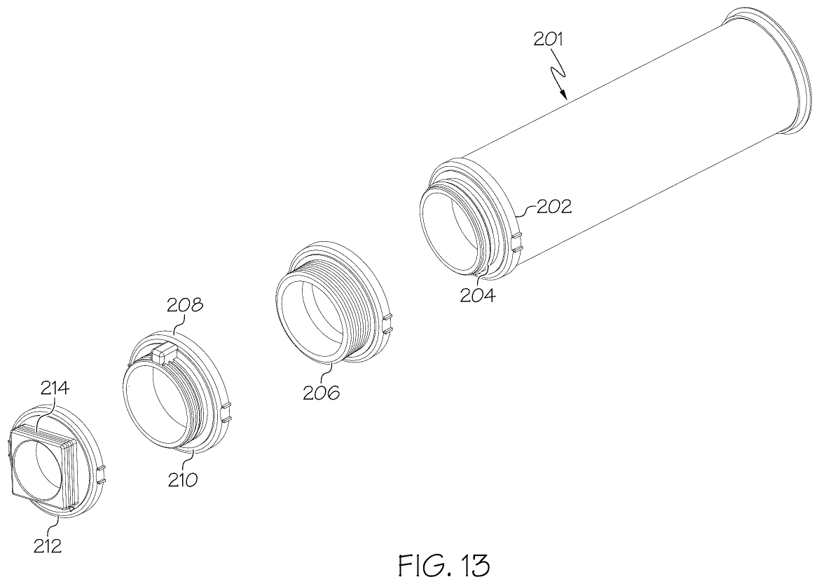

In general, in reference to FIG. 13, a filter element 201 (i.e., intake filter element 124, outtake filter element 170, or both) of the air drying unit 110 has a connection fitting such as a press fit connection 202 that has one or more O-rings 204, a threaded filter connection 206, a keyed filter connection 208 with a gasket 210, or a press fit connection 212 with a square seal ring 214.

In embodiments, an end cap 228A seals the second opening 132 of the intake filter housing 126. The end cap 228A may be removable to allow access for changing the intake filter elements 124 for periodic maintenance. In embodiments, the end cap 228A includes a mechanical closing and sealing mechanism that allow for simple maintenance.

In embodiments, for example, the embodiment shown in FIGS. 7A, 8, 9, and 12, the end cap 228A includes an external groove 230A while the intake filter housing 126 includes a corresponding external grove 230B located proximate to the second opening 132. The external groove 230A of the end cap 228A and the external groove 230B of the intake filter housing 126 receive a grooved fitting 150 (e.g., clamp 46 using ends 58) that couples the end cap 228A to the intake filter housing 126.

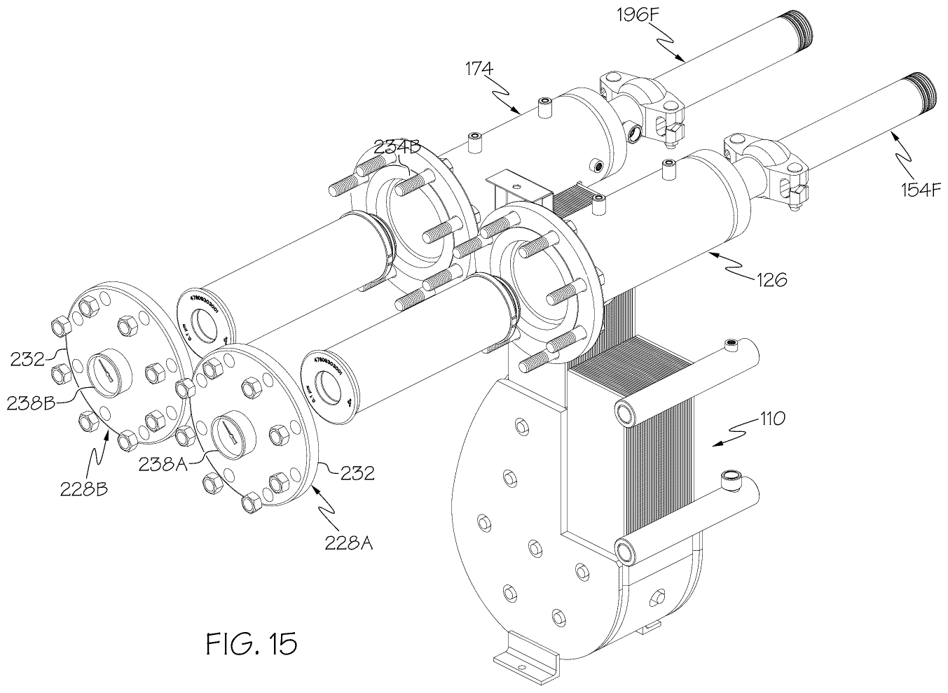

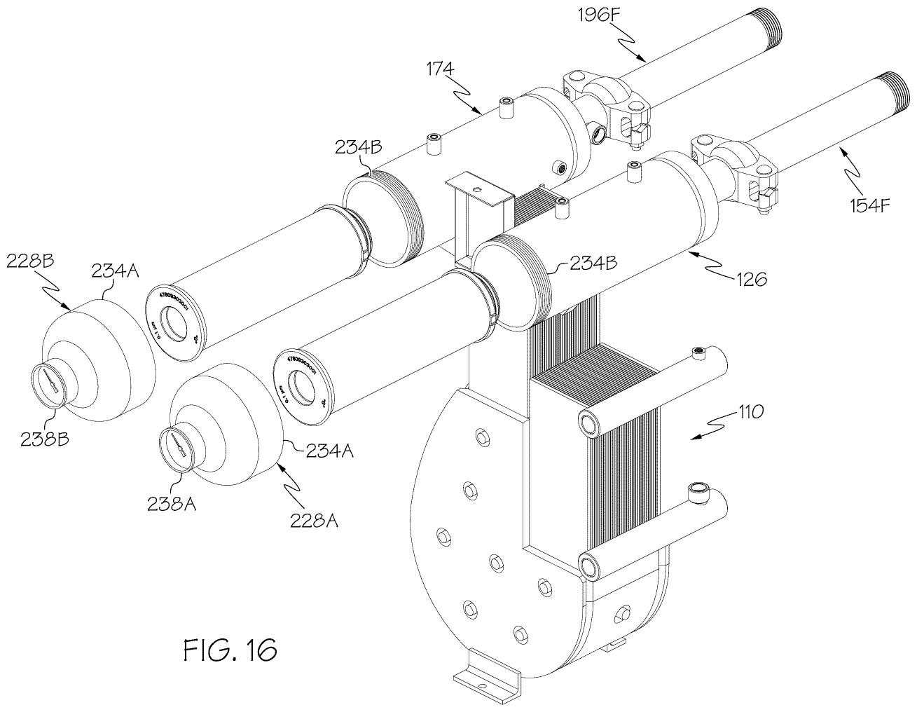

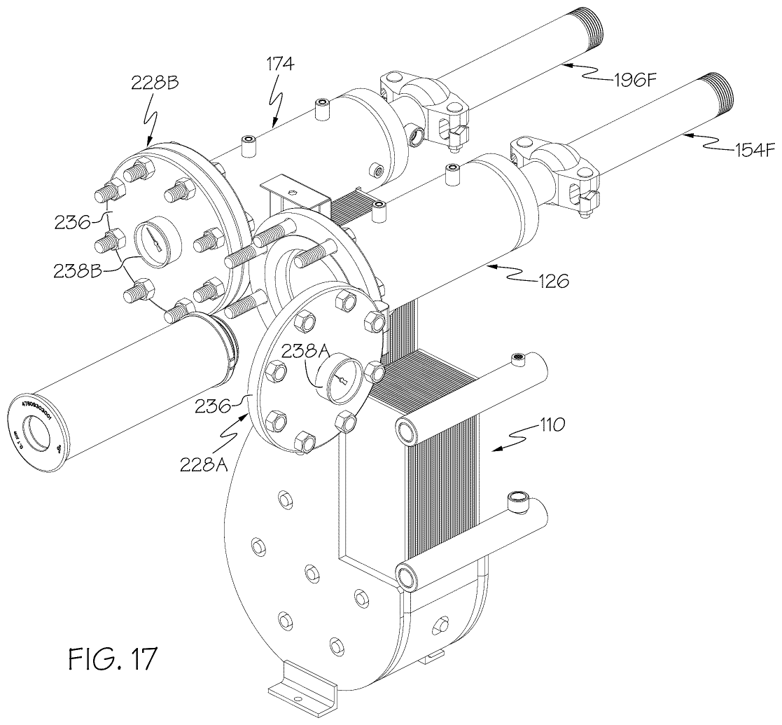

In other embodiments, for example, the embodiment shown in FIG. 15, the end cap 228A is a blind flange 232 that couples the end cap 228A to the intake filter housing 126 using multiple fasteners (e.g., bolts). In other embodiments, for example the embodiment shown in FIG. 16, the end cap 228A has a threaded fitting 234A that couples to a respective threaded fitting 234B of the intake filter housing 126. In other embodiments, for example the embodiment shown in FIG. 17, the end cap 228A is a hinged flange 236.

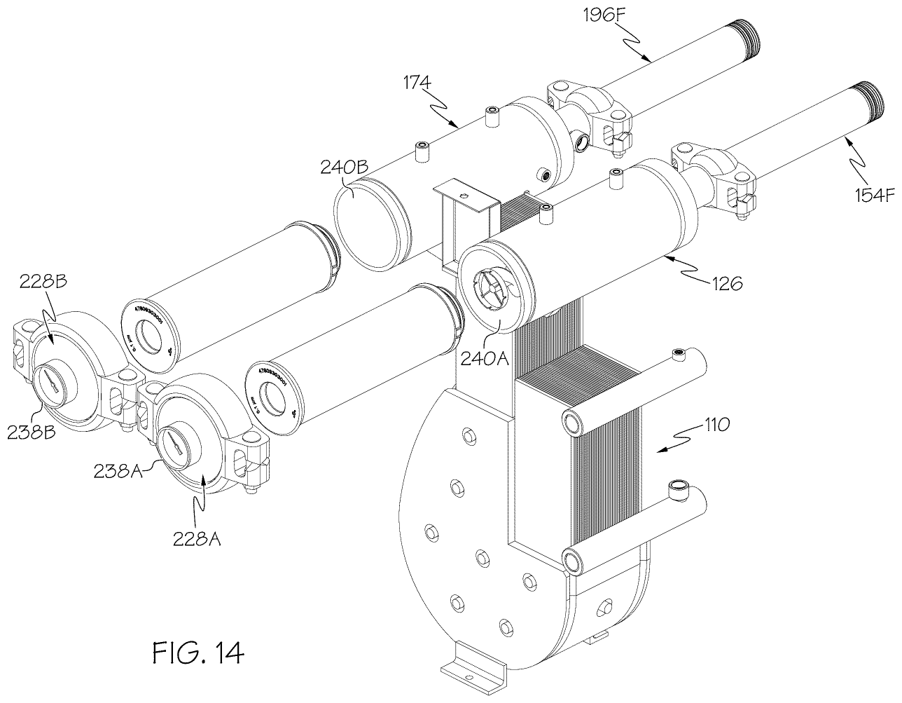

In embodiments, the end cap 228A includes a sampling point for measuring and monitoring the differential pressure of the air dryer unit 110. For example, as shown in FIGS. 14 through 17, the end cap 228A is drilled and tapped to have a measurement device 238A (e.g., a gauge or sensor) that is in fluid communication with the cavity 240A that is defined by the intake filter housing 126. In this embodiment, the end cap 142 includes one or more holes, or is made of porous material, that allows fluid communication between measurement device 238A and the cavity 240A. In embodiments, the measurement device 238A is configured to measure air or fluid pressure that is external and/or internal to the intake filter element 124, a temperature of the compressed air in the intake filter housing 126, a dew point of the compressed air in the intake filter housing 126, particulates, fungus, mold, combinations thereof, or the like.

In embodiments, for example, the embodiment shown in FIG. 7A, the end cap 228A includes a recess 242A configured to receive and seal the end cap 142 of the intake filter element 124.

In embodiments, an end cap 228B seals the second opening 182 of the outtake filter housing 174. The end cap 228B may be removable to allow access for changing the outtake filter elements 170 for periodic maintenance. In embodiments, the end cap 228B includes a mechanical closing and sealing mechanism that allow for simple maintenance.

In embodiments, for example the embodiments in FIGS. 7B, 8, and 9, the end cap 228B includes an external groove 244A and the outtake filter housing 174 includes a corresponding external grove 244B located proximate to the second opening 182. The external groove 244A of the end cap 228B and the external groove 244B the outtake filter housing 174 receive a grooved fitting 150 (e.g., clamp 46 using ends 58) that couples the end cap 228B to the outtake filter housing 174.

In other embodiments, for example, the embodiment shown in FIG. 15, the end cap 228B is a blind flange 232 that couples the end cap 228B to the outtake filter housing 174 using multiple bolts. In other embodiments, for example, the embodiment shown in FIG. 16, the end cap 228B has a threaded fitting 234A that couples to a respective threaded fitting 234B of the outtake filter housing 174. In other embodiments, for example, the embodiment shown in FIG. 17, the end cap 228B is a hinged flange 236.

In embodiments, the end cap 228B includes a sampling point for measuring and monitoring the differential pressure of the air dryer unit 110. For example, as shown in FIGS. 14 through 17, the end cap 228B is drilled and tapped to have a measurement device 238B (e.g., a gauge or sensor) that is in fluid communication with the cavity 240B that is defined by the outtake filter housing 174. In this embodiment, the end cap 188 includes one or more holes, or is made of porous material, that allows fluid communication between measurement device 238B and the cavity 240B. In embodiments, the measurement device is configured to measure air pressure that is external and/or internal to the outtake filter element 170, a temperature of the compressed air in the outtake filter housing 174, a dew point of the compressed air in the outtake filter housing 174, particulates, fungus, mold, combinations thereof, and so forth.

In embodiments, for example, the embodiments shown in FIG. 7B, the end cap 228B includes a recess 242B configured to receive and seal the endcap 188 of the outtake filter element 170.

In general, the intake and outtake filter elements 124, 170 can be of any type for insertion into the intake and outtake filtration sections 114, 122. In some embodiments, the intake and outtake filter elements 124, 170 are the same filter grade. In other embodiments, the intake and outtake filter elements 124, 170 are of different filter grades relative to each other. In one embodiment, the intake filter element 124 is a general-grade coalescing filtering element, while the outlet filter element 170 is a high-efficiency particulate filtering element.

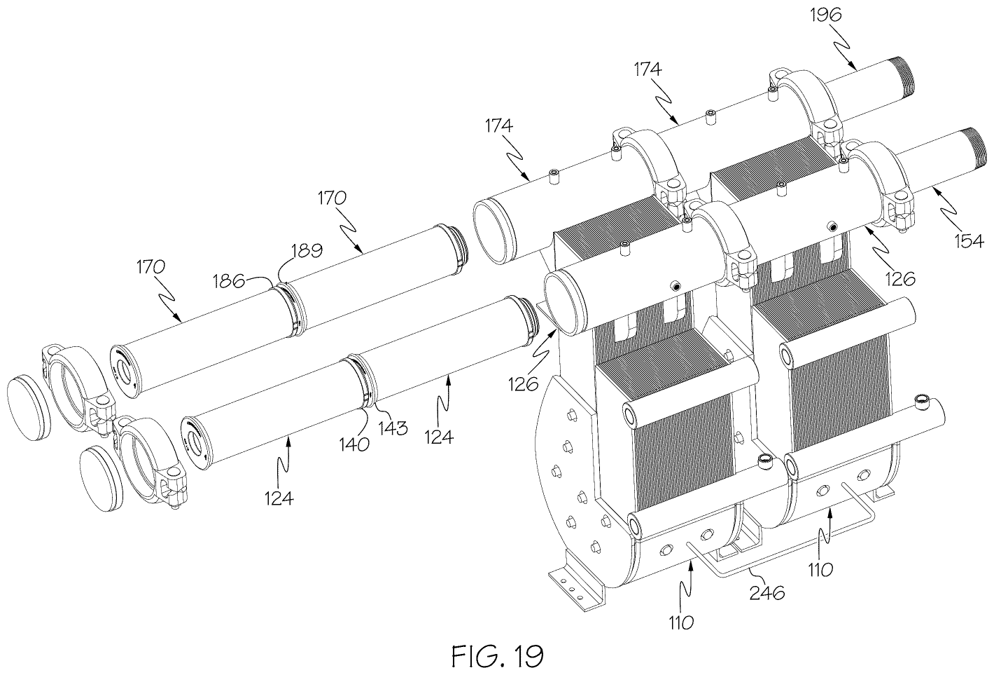

Referring to FIG. 19, an embodiment is depicted in which the air drying unit 110 is coupled with another air drying unit 110. In this embodiment, the intake filtration section 114 is configured to mechanically join two filter elements together (e.g., via filter connections 204, 206, 210, 212) to increase the overall filtration capacity to match the coupled air dryers flow capacity rating. In embodiments, instead of an endcap 142, 188, the intake filter element 124 and the outtake filter element 170 have a respective second opening 143, 189 that allows a portion of compressed air to pass through. In this embodiment, the second opening of the intake filter element 124 or the outtake filter element 170 (i.e., second opening 143, 189) is coupled with a first opening of a respective second intake filter element or second outtake filter element (i.e., first opening 140, 186) that is housed by a respective second intake filter housing 126 or second outtake filter housing 174 of a second air drying unit 110. In further embodiments, the conjoined filter elements are coupled using, but not limited to, a keyed coupling, a threaded coupling, a press fit, or the like. In embodiments, a conduit 246 fluidly couples each moisture separator section 120 of each air drying unit 110, which equalizes fluid pressure between each moisture separator section 120.

While various embodiments have been described, it should be understood that the embodiments are not limiting, and modifications may be made without departing from the embodiments herein. While each embodiment described herein may refer only to certain features and may not specifically refer to every feature described with respect to other embodiments, it should be recognized that the features described herein are interchangeable unless described otherwise, even where no reference is made to a specific feature. It should also be understood that the advantages described above are not necessarily the only advantages, and it is not necessarily expected that all of the described advantages will be achieved with every embodiment. Other examples may occur to those skilled in the art based on the present disclosure. Such other examples are intended to be within the scope of the present disclosure.

In reading the claims, it is intended that when words such as “a,” “an,” “at least one,” or “at least one portion” are used, there is no intention to limit the claim to only one item unless specifically stated to the contrary in the claim. When the language “at least a portion” and/or “a portion” is used, the item can include a portion and/or the entire item unless specifically stated to the contrary. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

What is claimed is:

1. An air drying unit with an integrated filtration system, the air drying unit comprising:
a precooler/reheater having a precooler air intake for receiving incoming compressed air, a reheater air outtake for discharging outgoing compressed air, and a heat exchanger for transferring heat between the incoming and outgoing compressed air such that the outgoing compressed air precools the incoming compressed air and the incoming compressed air reheats the outgoing compressed air;
a main cooler having a heat exchanger coupled to the precooler/reheater to receive the precooled compressed air and configured to receive a coolant for exchanging heat between the precooled compressed air and the coolant such that the coolant chills the precooled compressed air to cause moisture in the precooled compressed air to condense;
a moisture separator coupled to the main cooler and the precooler/reheater to receive the chilled compressed air containing the condensed moisture, the moisture separator configured to collect the condensed moisture and thereby dry the chilled compressed air to form the outgoing compressed air;
an intake filter housing having a sidewall that defines a first opening, a second opening, and a third opening, the first opening facing opposite to the second opening, the third opening located on the sidewall between the first opening and the second opening, the third opening coupled to the precooler air intake, the intake filter housing configured to receive compressed air from the first opening to the third opening to form the incoming compressed air;
an intake filter element housed by the intake filter housing, the intake filter element having a first opening and a sidewall, the sidewall of the filter element formed of a filter media configured to filter compressed air that passes through the filter media, wherein compressed air entering the first opening of the intake filter housing enters the first opening of the intake filter element, passes outward through the sidewall filter media, and exits the intake filter housing through the third opening of the intake filter housing;
an outtake filter housing having a sidewall that defines a first opening, a second opening, and a third opening, the first opening facing opposite to the second opening, the third opening located on the sidewall between the first opening and the second opening, the third opening coupled to the reheater air outtake, the outtake filter housing configured to receive the outgoing compressed air from the third opening to the first opening; and
an outtake filter element housed by the outtake filter housing, the outtake filter element having a first opening and a sidewall, the sidewall of the filter element formed of a filter media configured to filter compressed air that passes through the filter media, wherein compressed air entering the third opening of the outtake filter housing passes inward through the sidewall filter media and exits the first opening of the outtake filter element and the first opening of the outtake filter housing.

2. An air drying unit with an integrated filtration system, the air drying unit including a precooler/reheater, a main cooler, and a moisture separator, the air drying unit comprising:
an intake filter housing having a sidewall that defines a first opening, a second opening, and a third opening, the first opening facing opposite to the second opening, the third opening located on the sidewall between the first opening and the second opening, the third opening coupled to an air intake of the precooler/reheater, the intake filter housing configured to receive compressed air from the first opening to the third opening;
an intake filter element housed by the intake filter housing, the intake filter element having a first opening, and a sidewall, the sidewall of the filter element formed of a filter media configured to filter compressed air that passes through the filter media, wherein compressed air entering the first opening of the intake filter enters the first opening of the intake filter, passes outward through the sidewall filter media, and exits the intake filter housing through the third opening of the intake filter housing;
an outtake filter housing having a sidewall that defines a first opening, a second opening, and a third opening, the first opening facing opposite to the second opening, the third opening located on the sidewall between the first opening and the second opening, the third opening coupled to an air outtake of the precooler/reheater, the outtake filter housing configured to receive compressed air from the third opening to the first opening; and
an outtake filter element housed by the outtake filter housing, the outtake filter element having a first opening and a sidewall, the sidewall of the filter element formed of a filter media configured to filter compressed air that passes through the filter media, wherein compressed air entering the third opening of the outtake filter housing passes inward through the sidewall filter media and exits the first opening of the outtake filter element and the first opening of the outtake filter housing.

3. The air drying unit of claim 2, further comprising a first end cap coupled to the second opening of the intake filter housing and a second end cap coupled to the second opening of the outtake filter housing, wherein removal of the first end cap and the second end cap allows access to remove and replace the respective intake filter element and the outtake filter element.

4. The air drying unit of claim 3, wherein at least the first end cap or the second end cap further comprises a gauge or sensor in communication with a cavity defined by the intake filter housing or the outtake filter housing, the gauge or sensor configured to measure at least one of air pressure external or internal to the intake filter element or outtake filter element, a temperature of compressed air, or dew point compressed air.

5. The air drying unit of claim 3, wherein the first end cap and the second end cap each further comprise an external groove configured to receive a respective grooved fitting that respectively couples the first end cap and the second end cap to the intake filter housing and the outtake filter housing.

6. The air drying unit of claim 3, wherein the first end cap or the second end cap is a blind flange.

7. The air drying unit of claim 3, wherein the first end cap or the second end cap has a threaded fitting configured to couple to the respective intake filter housing or outtake filter housing.

8. The air drying unit of claim 3, wherein the first end cap or the second end cap is a hinged flange coupled to the respective intake filter housing or outtake filter housing.

9. The air drying unit of claim 3, wherein the first end cap and the second end cap each further comprise a recess configured to receive a respective endcap of the intake filter element and outtake filter element.

10. The air drying unit of claim 2, wherein the outtake filter housing and the intake filter housing each further comprise a circumferential groove located proximate to the respective first opening, the circumferential groove configured to receive a grooved fitting that couples the outtake filter housing and the intake filter housing to a respective onsite pipe connection.

11. The air drying unit of claim 2, wherein an onsite pipe connection is configured to receive a portion of either the intake filter element or the outtake filter element, the onsite pipe connection including a first pressure measurement tap and a second pressure measurement tap, the first pressure measurement tap receives an internal air pressure of the intake filter element or the outtake filter element, the second pressure measurement tap receives an external air pressure of the intake filter element or the outtake filter element, wherein a comparison between the internal air pressure and the external air pressure determines a condition state of the intake filter element or the outtake filter element.

12. The air drying unit of claim 2, wherein the outtake filter housing and the intake filter housing each further comprise a beveled edge located proximate to the respective first opening, the beveled edge configured to receive a weld fitting that couples the outtake filter housing and the intake filter housing to a respective onsite pipe connection.

13. The air drying unit of claim 2, wherein the intake filter housing or the outtake filter housing further comprise a first pressure measurement tap and a second pressure measurement tap, the first pressure measurement tap receives an internal air pressure of the intake filter element or the outtake filter element, the second pressure measurement tap receives an external air pressure of the intake filter element or the outtake filter element, wherein a comparison between the internal air pressure and the external air pressure determines a condition state of the intake filter element or the outtake filter element.

14. The air drying unit of claim 2, further comprising a filter diffuser housed by the intake filter element for diffusing compressed air substantially evenly across the filter media of the intake filter element.

15. The air drying unit of claim 14, wherein the filter diffuser includes a helical barrier that extends along an axis of the filter diffuser that diffuses the compressed air.

16. The air drying unit of claim 14, wherein the filter diffuser includes a tubular barrier that extends along an axis of the filter diffuser, the tubular barrier including a plurality of shrouds that radially extend from the tubular barrier, wherein the plurality of shrouds defines a respective plurality of slots that diffuse the compressed air.

17. The air drying unit of claim 2, wherein the intake filter housing or the outtake filter housing includes a first pressure measurement tap, an onsite pipe connection coupled to the intake filter housing or the outtake filter housing includes a second pressure measurement tap, the first pressure measurement tap receives an external air pressure of the intake filter element or the outtake filter element, the second pressure measurement tap receives an internal air pressure of the intake filter element or the outtake filter element, wherein a comparison between the internal air pressure and the external air pressure determines a condition state of the intake filter element or the outtake filter element.

18. The air drying unit of claim 2, wherein at least the intake filter element or the outtake filter element further comprises a respective second opening, wherein the second opening of the intake filter element or the outtake filter element is coupled with an opening of a respective second intake filter element or second outtake filter element that is housed by a respective second intake filter housing or second outtake filter housing of a second air drying unit.

19. An air drying unit with an integrated filtration system, the air drying unit including a precooler/reheater, a main cooler, and a moisture separator, the air drying unit comprising:
an intake filter housing having a sidewall that defines a first opening, a second opening, and a third opening, the first opening facing opposite to the second opening, the third opening located on the sidewall between the first opening and the second opening, the third opening coupled to an air intake of the precooler/reheater, the intake filter housing configured to receive compressed air from the first opening to the third opening; and
an intake filter element housed by the intake filter housing, the intake filter element having a first opening and a sidewall, the sidewall of the filter element formed of a filter media configured to filter compressed air that passes through the filter media, wherein compressed air entering the first opening of the intake filter enters the first opening of the intake filter, passes outward through the sidewall filter media, and exits the intake filter housing through the third opening of the intake filter housing.

20. The air drying unit of claim 19, wherein the intake filter element further comprises a second opening, the second opening facing opposite to the first opening, the second opening of the intake filter element coupled with an opening of a second intake filter element that is housed by a second intake filter housing of a second air drying unit.
